(19) United States
(12) Patent Application Publication
(10) Pub. No.: US 2023/0119441 A1
(43) Pub. Date: Apr. 20, 2023

(54) COMPOSITE COATING FOR INCREASING ATMOSPHERIC CONDENSATION ON A SURFACE OF A SUBSTRATE

(71) Applicant: THE UNIVERSITY OF SYDNEY, Sydney, New South Wales (AU)

(72) Inventors: CHIARA NETO, Sydney, New South Wales (AU); MARTIJN DE STERKE, Sydney, New South Wales (AU); MING CHIU, Sydney, New South Wales (AU)

(73) Assignee: THE UNIVERSITY OF SYDNEY, Sydney, New South Wales (AU)

(21) Appl. No.: 17/911,114

(22) PCT Filed: Mar. 12, 2021
(86) PCT No.: PCT/AU2021/050221

§ 371 Date: Sep. 12, 2022

(30) Foreign Application Priority Data
Mar. 13, 2020 (AU) 2020900774

(51) Int. Cl. C09D 127/20; C09D 5/33; C09D 7/20; C09D 7/61; C09D 127/16; C09D 183/04; B01D 5/00

(52) U.S. Cl. CPC C09D 127/20; B01D 5/009; B01D 5/0027; C09D 5/004; C09D 7/20; C09D 7/61; C09D 127/16; C09D 183/04

(57) ABSTRACT

Composite coatings that passively cool when exposed to the sky are provided. The composite coatings are suitable for increasing atmospheric condensation on a surface of a substrate. In particular, the composite coatings may be suitable for capturing atmospheric water. Also provided are methods for producing the composites coatings, methods for coating the surface of substrates with the composite coatings, methods for condensing and collecting atmospheric water, and systems for collecting condensed atmospheric water.

### FIELD

The present disclosure relates to a composite coating that passively cools when exposed to the sky and is suitable for increasing atmospheric condensation on a surface of a substrate. In particular, the composite coating may be suitable for capturing atmospheric water.

### BACKGROUND

The stable, sustainable supply of clean water is one of this century’s most significant global challenges. For Australia, one of the driest continents, it is particularly important as drought affects entire communities and ecosystems. The cost of the millennium drought from the late 1990s was estimated at $40B. While desalination can supplement water consumption during prolonged draught, it is energy-intensive and requires a high capital investment. Identifying a new sustainable source of water will help alleviate water shortages in the future.

Harvesting water from humid ambient air or atmospheric water capture (AWC) offers an alternative to the conventional means of obtaining water. Water can be harvested from the air using various methods. AWC technology, if successfully exploited on a large scale, could potentially have enormous, sustainable economic and environmental consequences by supporting livelihoods and farming, especially those in remote regions. It could provide drinking water for people, for farm animals and for wild animals, and have the potential to increase water use efficiency for irrigation in green houses and other horticultural settings and for water intensive crops such as cotton.

The most common AWC methods presently known in the art are (i) condensation, i.e., cooling the air below its dew point or (ii) absorption via desiccants. However, these methods generally require an external source of energy either to provide active cooling in the case of the condensation technique or to drive captured water from the desiccants for harvesting.

Despite a variety of scientific efforts to realise AWC on a scale that can have societal impact, two outstanding scientific challenges limit its use: (1) water condenses only on cold surfaces, which require a continuous supply of energy; and (2) in order to collect large volumes of water, the collecting devices need to cover a large area (i.e. several m² and above).

Accordingly, there is a need for developing materials for AWC that may provide passive cooling to surfaces and that may be suitable for fabricating large scale collection areas in a cost effective manner. These materials should also provide increased or improved atmospheric water collection on surfaces. There is also a need for developing surfaces that facilitate the condensation of water in other applications, such as for example for desalination. There is also a need for developing surfaces that may use active cooling obtained through the use of solar cells that provide additional cooling power to the surface and therefore increased water collection yield. In addition, there is a need to cool structures in hot climates such as buildings with the use of reduced energy, and/or to increase the efficiency of the cooling of a structure, by using functional coatings.

The present disclosure addresses one or more of these aforementioned needs.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF DISCLOSURE

The present disclosure describes a new composite coating that increases atmospheric condensation on a surface of a substrate. The new composite coating exhibits sub-ambient surface cooling even during day time. Additionally, the new composite coating possesses water droplet nucleation properties that may be suitable for atmospheric water capture applications.

According to a first aspect of the present disclosure there is provided a composite coating for increasing atmospheric condensation on a surface of a substrate, wherein the composite coating comprises:
a hydrophobic polymer; and
wherein the composite coating comprises a plurality of inclusions.

In embodiments, the inclusions comprise voids. In some embodiments the composite coating has a percentage void volume of about 20% or more.

In embodiments, the hydrophobic polymer comprises fluoropolymer, organosiloxane, or a blend thereof. In embodiments, the hydrophobic polymer comprises PVDF-HFP, PDMS, or blends thereof. The hydrophobic polymer may, for example, comprise PDMS, or a modified PDMS.

In embodiments, the composite coating further comprises a hydrophilic substance. The hydrophilic substance comprises one or more of inorganic particles and hydrophilic polymers.

The inorganic particles may comprise silica particles. The silica particles may comprise polydisperse silica nano/micro-particles, having a diameter of from about 0.25 µm to about 20 µm. The silica particles may comprise monodisperse silica nano/micro-particles having a mean diameter of from about 0.25 µm to about 8 µm.

The hydrophilic polymers may comprise one or more of polyacrylates, polyesters and polyethers. The hydrophilic polymers may comprise one or more of PMMA and PEG.

In embodiments, the composite coating further comprises one or more surface modifying agents comprising one or more of polyurethane, polystyrene and silane.

In embodiments the composite coating comprises at least two layers, wherein an outer layer comprises one or more surface modifying agents comprising organosiloxane, polyurethane, fluoropolymer, polystyrene, polyacrylate and silane. The one or more surface modifying agents may comprise one or more of PDMS, PVDF, PMMA, alkylsilane and haloalkylsilane.

In some embodiments the surface of the composite coating comprises hydrophobic and hydrophilic regions and/or topographical bumps.

The composite coating according to the present disclosure provides one or more of the following advantages;
the composite coating may provide an increased cooling effect when coated on a substrate and exposed to the sky, relative to a substrate absent the coating;
the composite coating may enable condensed atmospheric water to easily roll off a surface at low tilt angles, for example tilt angles of less than 20° from horizontal.

According to a second aspect of the present disclosure there is provided a liquid composite coating, said liquid composite coating comprising a composite coating according to any one of the herein disclosed embodiments and:
a solvent which is capable of substantially dissolving the hydrophobic polymer; and
a non-solvent, in which the hydrophobic polymer is insoluble, or only sparingly soluble.

The mass ratio of the hydrophobic polymer to the solvent may be from about 1:10 to about 1:5. The mass ratio of the solvent to the non-solvent may be from about 10:1 to about 5:1.

The non-solvent may comprise water.

The solvent may comprise a water-miscible organic solvent. The water-miscible organic solvent may have a higher vapour pressure at 20° C. than water. The water-miscible organic solvent may comprise one or more of acetone, tetrahydrofuran, and 1,3-dioxolane.

In some embodiments N-methyl-2-pyrrolidone may be added to the liquid composite coating as a solubility regulator.

In certain embodiments the composite coating comprises:
PVDF-HFP, comprising from 5% (w/w) to 35% (w/w) HFP;
and optionally one or more of
silica nano/micro-particles;
N-methyl-2-pyrrolidone;
polyurethane, PVDF, PMMA, polystyrene, PDMS, or a combination thereof; and
one or more alkylhalosilanes;
wherein the composite coating comprises a plurality of voids, and has a percentage void volume of about 20% or more. In embodiments, the percentage void volume is about 50% or more. In embodiments, the surface of the coating comprises hydrophobic and hydrophilic regions and/or topographical bumps.

In certain embodiments the liquid composite coating comprises:
PVDF-HFP, comprising from 5% (w/w) to 35% (w/w) HFP;
water;
one or more of acetone, 1,3-dioxolane and tetrahydrofuran;
and optionally one or more of
silica microspheres;
N-methyl-2-pyrrolidone;
PMMA; and
one or more alkylhalosilanes;
wherein the mass ratio of the PVDF-HFP and PMMA to acetone, 1,3 dioxolane, tetrahydrofuran, or a combination thereof to water in the liquid composite coating is about 10 ± 2 : 80±10 : 10±2.

In certain embodiments the liquid composite coating comprises:
PVDF-HFP, comprising from 5% (w/w) to 35% (w/w) HFP;
silica microspheres;
one or more of acetone, 1,3 dioxolane and tetrahydrofuran;
water;
N-methyl-2-pyrrolidone;
PMMA; and
one or more alkylhalosilanes;
wherein the mass ratio of the PVDF-HFP and PMMA to acetone, 1,3 dioxolane, tetrahydrofuran, or a combination thereof to water in the liquid composite coating is about 10 ± 2 : 80±10 : 10±2.

According to a third aspect of the present disclosure there is provided a method for producing a liquid composite coating according to any one of the herein disclosed embodiments, comprising:
mixing a hydrophobic polymer and, optionally hydrophilic substance and surface modifying agents, and a solvent together to form a mixture, wherein the solvent is capable of at least partially dissolving the hydrophobic polymer; and
adding a non-solvent to the mixture to form the liquid composite coating, wherein the hydrophobic polymer is insoluble, or sparingly soluble in the non-solvent.

According to a fourth aspect of the present disclosure there is provided a method for coating a surface of a substrate with a composite coating according to any one of the herein disclosed embodiments, comprising applying the liquid composite coating according to any one of the herein disclosed embodiments to the surface of the substrate, and removing at least a portion of the solvent and/or non-solvent to form the composite coating. In embodiments, substantially all of the solvent and/or non-solvent is removed by, for example, evaporation.

According to a fifth aspect of the present disclosure there is provided method for coating a surface of a substrate with a composite coating according to any one of the herein disclosed embodiments, comprising:
applying the liquid composite coating according to any one of the herein disclosed embodiments to the surface of the substrate;
removing at least a portion of the solvent and/or non-solvent from the liquid composite coating to form a first layer of the composite coating; and
applying one or more surface modifying agents comprising organosiloxane, polyurethane, fluoropolymer, polystyrene and polyacrylate to the first layer to form a second layer of the composite coating.

In embodiments the one or more surface modifying agents comprise one or more of PDMS, PVDF and PMMA.

In embodiments, the methods according to the fourth and fifth aspects further comprising applying a primer to the substrate prior to applying the liquid composite coating.

In embodiments, the primer comprises one or more of acrylic, epoxy and polyurethane polymer, anticorrosion pigment, reflective pigment, IR emitter (for example SiC and Si₃N₄) and adhesion promoting additives.

In alternate or additional embodiments the surface of the substrate may be treated to increase surface roughness, such as by sanding, so as to improve adhesion of the composite coating.

According to a sixth aspect of the present disclosure there is provided a method for increasing atmospheric condensation on a surface of a substrate, comprising coating the substrate with the composite coating according to any one of the herein disclosed embodiments and exposing the coated substrate to sky.

In embodiments, the method comprises cooling a surface of the substrate.

According to a seventh aspect of the present disclosure there is provided a method for collecting atmospheric water, said method comprising:
exposing a substrate coated with the composite coating accoding to any one of the herein disclosed embodiments to sky, under atmospheric conditions having a relative humidity of about 30% or more, to condense atmospheric water on the coated substrate; and
collecting the condensed atmospheric water.

In embodiments, the relative humidity is 50% or more.

In embodiments, between 0.01 L and 2 L of condensed water is collected per m² of coated substrate surface per 24 hour day.

In alternate embodiments, greater than 0.1 L of condensed water is collected per m² of coated substrate surface per 24 hour day.

In alternate embodiments, greater than 0.3 L of condensed water is collected per m² of coated substrate surface per 24 hour day.

In alternate embodiments, greater than 0.5 L of condensed water is collected per m² of coated substrate surface per 24 hour day.

According to an eighth aspect of the present disclosure there is provided a system for collecting condensed atmospheric water, said system comprising:
a substrate coated with the composite coating according to any one of the herein disclosed embodiments, wherein the coated substrate is exposed to the sky; and
means for transporting condensed atmospheric water from the coated substrate to one or more collection units.

In embodiments, at least one surface of the coated substrate is tilted relative to horizontal.

In embodiments, the system further comprises at least one primer layer disposed between the substrate and the composite coating.

In embodiments, the composite coating comprises an outer layer comprising one or more surface modifying agents.

In embodiments of the methods and systems of the present disclosure, the substrate is an external surface of an object that is exposed to the sky.

In embodiments of the methods and systems of the present disclosure, the object is one or more of a roof, a wall and a panel.

In embodiments of the methods and systems of the present disclosure, the substrate comprises one or more of wood, glass, paper, textile, cement, concrete, plastic, metal, ceramic, and composite materials.

In any one or more of the hereinbefore aspects or embodiments the composite coatings of the present disclosure may, upon application to the surface of a substrate, form a coating having a thickness from about 50 µm to about 500 µm, or from about 50 µm to about 300 µm, or from about 50 µm to about 200 µm.

In embodiments wherein the composite coating comprises two layers, the thickness of the first layer (cooling layer comprising hydrophobic polymer) may have a thickness from about 50 µm to about 500 µm, or from about 50 µm to about 300 µm, or from about 50 µm to about 200 µm.

The thickness of the second layer comprising one or more surface modifying agents comprising organosiloxane, polyurethane, fluoropolymer, polystyrene and polyacrylate may be at least about 500 nm, or at least about 1 µm, or at least about 2 µm, or at least about 5 µm, or between about 500 nm and about 10 µm.

In embodiments, the thickness of the first layer is from about 50 µm to about 200 µm and the thickness of the second layer is from about 500 nm to about 10 µm.

In embodiments of the methods and systems of the present disclosure, a surface of the composite coating may comprise hydrophobic and hydrophilic regions and/or topographical bumps. Alternatively, the surface of the composite coating may comprise a smooth hydrophobic surface that facilitates roll-off of water droplets.

Further aspects of the present invention and further embodiments of the aspects described in the preceding paragraphs will become apparent from the following description, given by way of example and with reference to the accompanying drawings.

### BRIEF DESCRIPTION OF DRAWINGS

FIG. 1: schematic depiction showing how an example composite coating according to the present disclosure can be used to collect atmospheric water.

FIG. 2: (a) photograph of a custom-built experimental assembly used to assess the passive cooling performance of composite coatings under open sky conditions and including a weather station; (b) photograph of a composite coating of 200 mm in diameter; (c) photographs of a composite coating taken with a regular camera (left hand) and IR camera (right hand); the temperature in the IR image is indicated with a color scale between 15° C. (dark) and 35° C. (bright).

FIG. 3: schematic depiction of a custom-built assembly for cooling composite coatings and collecting condensed water.

FIG. 4: 3-dimensional depiction of a custom built assembly for cooling composite coatings and collecting condensed water.

FIG. 5: SEM micrograph of the porous surface and SEM micrograph of the cross section of a composite coating prepared according to one embodiment of the present disclosure.

FIG. 6: top left, the spectral reflectivity over solar wavelengths (λ = 0.3 - 2.5 µm) of composite coatings prepare according to one embodiment of the present disclosure, at various film thicknesses; at top right, ASTM G173-03 Solar Spectrum Irradiance vs. non-reflected irradiance of an approx. 200 µm thick composite coating, with 0.934 total solar reflectance; at middle left, the spectral emissivity over atmospheric window (λ = 8 - 13 µm) of approx. 100 µm thick composite coating; at middle right, the blackbody radiation spectrum at 300 K vs. emission spectrum of composite coating approx. 100 µm thick, with 0.956 total atmospheric window emittance; at bottom left, the advancing contact angle (ACA) and receding contact angle (RCA) of water over the composite coating surface; and at bottom right, a 30 µL water droplet over a composite coating surface inclined at 60°.

FIG. 7: illustrates the surface temperature of composite coating vs. ambient temperature under open sky during daytime with the measured solar irradiance intensity shown in shading.

FIG. 8: illustrates, at left, water droplets condensed on the surface of composite coating in laboratory condensation chamber at 10° C. below dew point and 85% relative humidity, and, at right, water collected over time.

FIG. 9: illustrates a SEM micrograph of the surface of the composite film and of the cross section of the composite film prepared according to one embodiment of the present disclosure.

FIG. 10: at top left, illustrates spectral reflectivity over solar wavelengths (λ = 0.3 - 2.5 µm) of composite coatings at approx. 90 µm thickness; at top right, the ASTM G173-03 Solar Spectrum Irradiance vs. non-reflected irradiance of an approx. 90 µm thick composite coating, with 0.867 total solar reflectance; at middle left, the spectral emissivity over atmospheric window (λ = 8 - 13 µm) of approx. 90 µm thick composite coating; at middle right, the blackbody radiation spectrum at 300 K vs. emission spectrum of composite coating approx. 90 µm thick, with 0.941 total atmospheric window emittance; at bottom left, the advancing contact angle (ACA) and receding contact angle (RCA) of water over the composite coating surface; at bottom right, illustrates a 30 µL water droplet over an inclined composite coating surface at 60°.

FIG. 11: at left, illustrates water droplets condensed on the surface of composite coating in laboratory condensation chamber at 10° C. below dew point and 85% relative humidity; and at right, illustrates water collected over time and rate of condensation.

FIG. 12: illustrates the SEM micrograph of the surface of the composite and of the cross section of the composite according to embodiments of the present disclosure.

FIG. 13: at top left, illustrates spectral reflectivity over solar wavelengths (λ = 0.3 - 2.5 µm) of composite coatings at approx. 90 µm thickness; at top right, illustrates the ASTM G173-03 Solar Spectrum Irradiance vs. non-reflected irradiance of an approx. 90 µm thick composite coating with 0.873 total solar reflectance; at middle left, shows spectral emissivity over atmospheric window (λ = 8 - 13 µm) of approx. 160 µm thick composite coating; (middle right) shows blackbody radiation spectrum at 300 K vs. emission spectrum of composite coating at approx. 90 µm thick with 0.941 total atmospheric window emittance; at bottom left, shows advancing contact angle (ACA) and receding contact angle (RCA) of water over the composite coating surface; at bottom right, shows a 15 µL water droplet rolling off a composite coating surface inclined at 10°.

FIG. 14: at left, shows water droplets condensed on the surface of composite coating in laboratory condensation chamber at 10° C. below dew point and 85% relative humidity; and at right a plot of water collected over time.

FIG. 15: Optical microscopy images of water collected on: (A) a surface coated with an example composite coating according to the present disclosure; and (B) a control surface.

### DEFINITIONS

As used herein, the term “about”, is relative to the actual value stated, as will be appreciated by those of skill in the art, and allows for approximations, inaccuracies and limits of measurement under the relevant circumstances.

As used herein, the term “comprising” indicates the presence of the specified integer(s), but allows for the possibility of other integers, unspecified. This term does not imply any particular proportion of the specified integers. Variations of the word “comprising”, such as “comprise” and “comprises”, have correspondingly similar meanings.

As used herein, the phrase “increasing atmospheric condensation on a surface of a substrate” in relation to the composite coating means that a surface of a substrate which is coated with the composite coating, when exposed to the sky under atmospheric conditions having relative humidity of 30% or more, has a greater quantity of water condensed on its surface over a period of time when compared with an uncoated surface of the substrate exposed to the same conditions over the same period of time.

As used herein, the term “hydrophobic” with respect to a material (e.g. a polymer), means a material when formed as a layer having a water droplet contact angle of greater than or equal to about 90°. In certain embodiments it may mean a material that repels water. In certain embodiments it may mean a material on which water droplets roll-off easily at low tilt angles.

As used herein, the term “hydrophilic” with respect to a material (e.g. a substance), means a material when formed as a layer having a water droplet contact angle of less than about 90°. In certain embodiments it may mean a material on which water spreads or partially spreads. In certain embodiments it may mean a material that reduces the energy barrier for droplet nucleation.

As used herein, the term “inclusions” with respect to the composite coating, means discrete portions of the composite coating that have a distinct density or chemical composition when compared with the density or chemical composition of the bulk composite coating.

### Abbreviations

AWC: atmospheric water collection; ECTFE: poly(ethylene chlorotrifluoroethylene); ETFE: poly(ethylene tetrafluoroethylene); FEP: fluorinated ethylene-propylene; IR: infrared electromagnetic radiation; NMP: N-methyl-2-pyrrolidone; OTS: octadecyl trichlorosilane; PCTFE: polychlorotrifluoroethylene; PDMS: polydimethylsiloxane; PEG: poly(ethylene glycol); PFA: perfluoroalkoxy polymer; PFPE: perfluoropolyether; PMMA: poly(methyl methacrylate); PS: polystyrene; PTFE: polytetrafluoroethylene; PVA: poly(vinyl alcohol); PVDF: polyvinylidene fluoride; PVDF-HFP: poly(vinylidene fluoride-co-hexafluoropropylene); RH: relative humidity; SEM: scanning electron microscopy; UV-vis: ultraviolet-visible light electromagnetic radiation.

### DESCRIPTION OF EMBODIMENTS

Disclosed herein is a composite coating for increasing atmospheric condensation on a surface of a substrate and increasing the subsequent collection of condensed water. The composite coating comprises a hydrophobic polymer and a plurality of inclusions.

### Composite Coating

The composite coating may be, for example, a substantially dry and/or cured coating on a substrate. That is, it may be substantially free of low boiling point solvents and/or low boiling point carriers (e.g. having a boiling point below about 180° C.). The liquid composite coating may be, for example, a paint composition comprising solvents or other carriers designed to be removed through, for example, evaporation upon application of the liquid composite coating onto a substrate surface.

The inclusions may be discrete portions of the composite coating that have a distinct density or chemical composition when compared with the density or chemical composition of the bulk composite coating. The inclusions may comprise voids and/or solid components and/or liquid components. The inclusions may comprise, for example, hydrophilic materials, such as silica particles. The inclusions may comprise surface modifications. The inclusions may be within the bulk of the composite coating, or they may be substantially at the surface, or within the bulk and at the surface of the composite coating.

The range of inclusion diameter may be from about 0.001 µm to about 100 µm, or it may be from about 0.001 µm to about 50 µm, about 0.001 µm to about 20 µm, about 0.001 µm to about 10 µm, about 0.001 µm to about 5 µm, about 0.05 µm to about 5 µm, about 0.5 µm to about 100 µm, about 1 µm to about 100 µm, about 2 µm to about 100 µm, about 5 µm to about 100 µm, about 1 µm to about 50 µm, about 1 µm to about 20 µm, or about 1 µm to about 10 µm.

The composite coating may have a percentage inclusion volume of about 20% or more, or about 25%, 30%, 35%, 40%, 45%, or 50% or more relative to the total volume of the composite coating. It may have a percentage inclusion volume of from about 20% to about 70%, or from about 25% to about 70%, about 30% to about 70%, about 35% to about 70%, about 40% to about 70%, about 50% to about 70%, about 30% to about 65%, or about 30% to about 60% relative to the total volume of the composite coating. It may have a percentage inclusion volume of, for example, about 20, 25, 30, 35, 40, 45, 50, 55, 60, 65, or 70% relative to the total volume of the composite coating.

The inclusions may comprise voids. The inclusions may, for example, be voids. The voids may be open pores connected with an outer surface of the composite coating, or closed (i.e. encapsulated) voids that are not connected with an outer surface of the composite coating, or combinations thereof.

The composite coating may have a percentage void volume of about 20% or more, or about 25%, 30%, 35%, 40%, 45%, or 50% or more. It may have a percentage void volume of from about 20% to about 70%, or from about 25% to about 70%, about 30% to about 70%, about 35% to about 70%, about 40% to about 70%, about 50% to about 70%, about 30% to about 65%, or about 30% to about 60%. It may have a percentage void volume of, for example, about 20, 25, 30, 35, 40, 45, 50, 55, 60, 65, or 70%.

The range of void diameter may be from about 0.001 µm to about 100 µm, or it may be from about 0.001 µm to about 50 µm, about 0.001 µm to about 20 µm, about 0.001 µm to about 10 µm, about 0.001 µm to about 5 µm, about 0.05 µm to about 5 µm, about 0.5 µm to about 100 µm, about 1 µm to about 100 µm, about 2 µm to about 100 µm, about 5 µm to about 100 µm, about 1 µm to about 50 µm, about 1 µm to about 20 µm, or about 1 µm to about 10 µm. The skilled person will understand that the proportion and size of air voids may be tuned by controlling the amount of solvent and non-solvent, and the environmental conditions (e.g. the humidity) during preparation of the composite coating.

Without being bound by theory, the porous composite structure may induce radiative daytime cooling of the surface, i.e. the surface may be cooler than the surrounding air, even when exposed to the direct sun. The surface may emit heat by IR radiation when exposed to the sky. In some embodiments, the composite coating need not contain any components (such as pigments or other polymers) that absorb UV-vis radiation which may induce heating.

The liquid composite coating may further comprise a solvent which is capable of substantially dissolving the hydrophobic polymer, and a non-solvent, in which the hydrophobic polymer is insoluble, or only sparingly soluble.

The non-solvent may comprise an aqueous solvent. It may comprise water. The mass ratio of the solvent to the non-solvent may be from about 50:1 to about 1:1, or from about 40:1 to about 1:1, about 30:1 to about 1:1, about 20:1 to about 1:1, about 15:1 to about 1:1, about 10:1 to about 1:1, about 50:1 to about 2:1, about 50:1 to about 3:1, about 30:1 to about 3:1, about 20:1 to about 5:1, or about 10:1 to about 5:1. It may be, for example, about 50:1, 40:1, 30:1, 20:1, 10:1, 9:1, 8:1, 7:1, 6:1, 5:1, 4:1, 3:1, 2:1, or 1:1.

The solvent may comprise a water-miscible organic solvent. The water-miscible organic solvent may have a higher vapour pressure at 20° C. than water. The water-miscible organic solvent may be selected from the group consisting of acetone, tetrahydrofuran, 1,3-dioxolane, and combinations thereof.

The mass ratio of the hydrophobic polymer to the solvent may be from about 1:20 to about 1:5, or from about 1:15 to about 1:5, about 1:12 to about 1:5, about 1:10 to about 1:5, about 1:9 to about 1:5, about 1:10 to about 1:6, about 1:10 to about 1:7, or about 1:9 to about 1:7. It may be, for example, about 1:20, 1:18, 1:16, 1:14, 1:12, 1:10, 1:9, 1:8, 1:7, 1:6, or 1:5.

The mass ratio of the hydrophobic polymer to the non-solvent may be from about 1:2 to about 10:1, or from about 1:1 to about 10:1, about 2:1 to about 10:1, about 4:1 to about 10:1, about 1:2 to about 4:1, or about 1:2 to about 2:1. It may be, for example, about 1:2, 1:1.5, 1:1, 1.5:1, 2:1, 3:1, 4:1, 5:1, 6:1, 7:1, 8:1, 9:1, or 10:1.

The composite coating may further comprise one or more surface modifying agents selected from the group consisting of PDMS, polyurethane, PVDF, PMMA, polystyrene, and organosiloxanes. The one or more surface modifying agents may comprise an alkylhalosilane. It may comprise OTS. The one or more surface modifying agents may hydrophilise and/or hydrophobise a surface of the composite coating. Without being bound by theory, surface hydrophobisation may have the effect of improving water drop roll-off thereby enhancing water capture rates and/or may reduce fouling of the surface by dust and other contaminants.

The one or more surface modifying agents may provide a mechanical protection layer for a surface of the composite coating, that is to protect the composite coating from mechanical damage, such as scratching. In embodiments, the one or more surface modifying agents may form an outer layer of the composite coating. The one or more surface modifying agents may be present in an amount of from about 0.01% to about 10% w/w in relation to the total mass of the composite coating, or it may be from about 0.01% to about 8%, about 0.01% to about 6%, about 0.01% to about 5%, about 0.01% to about 1%, about 0.1% to about 10%, about 0.2% to about 10%, about 0.5% to about 10%, about 1% to about 10%, about 0.1 % to about 8%, about 0.1% to about 5%, about 0.1% to about 2%, or about 0.01% to about 1% w/w in relation to the total mass of the composite coating. It may be, for example, present in an amount of about 0.01, 0.02, 0.05, 0.1, 0.2, 0.3, 0.4, 0.5, 0.6, 0.7, 0.8, 0.9, 1, 1.5, 2, 3.5, 4, 4.5, 5, 6, 7, 8, 9, or 10% w/w in relation to the total mass of the composite coating.

The liquid composite coating may further comprise one or more solubility improvers. The one or more solubility improvers may be substantially soluble in both the solvent and non-solvent. The one or more solubility improvers may, for example, comprise NMP. The one or more solubility improvers may be present in an amount of from about 0.1% to about 10% w/w in relation to the total mass of the composite coating, or it may be from about 0.1% to about 5%, about 0.1% to about 4%, about 0.1% to about 3%, about 0.1% to about 2%, about 0.1% to about 1%, about 0.2% to about 10%, about 0.5% to about 10%, about 1% to about 10%, about 0.1 % to about 8%, about 0.1% to about 5%, about 0.1% to about 2%, or about 0.1% to about 0.5% w/w in relation to the total mass of the composite coating. They may be, for example, present in an amount of about 0.1, 0.2, 0.3, 0.4, 0.5, 0.6, 0.7, 0.8, 0.9, 1, 1.5, 2, 3.5, 4, 4.5, 5, 6, 7, 8, 9, or 10% w/w in relation to the total mass of the composite coating.

The composite coating may form a film. The coating or film may have a thickness of from about 10 µm to about 1000 µm, or about 50 µm to about 1000 µm, about 100 µm to about 1000 µm, about 200 µm to about 1000 µm, about 500 µm to about 1000 µm, about 100 µm to about 1000 µm, about 50 µm to about 500 µm, about 50 µm to about 200 µm, about 50 µm to about 100 µm, or about 100 µm to about 500 µm. It may have a thickness of, for example, about 10, 20, 50, 60, 70, 80, 90, 100, 150, 200, 250, 300, 350, 400, 450, 500, 600, 700, 800, 900, or 1000 µm. The skilled person will understand that the coating or film thickness may depend upon the method used to form the coating or film and/or whether the coating or film is in a wet (i.e. comprises a solvent) or dry form (i.e. where the solvent has been removed, optionally evaporated). The skilled person will understand, for example, that the coating or film may have a thickness greater than 1000 µm if it is a wet coating or film formed using a mould process.

A surface of the composite coating may comprise hydrophobic and hydrophilic regions and/or topographical bumps. The hydrophobic regions may be as a result of the hydrophobic polymer in the composite coating. The hydrophilic regions may be as a result of the hydrophilic substance in the composite coating. The topographical bumps may be as a result of particles, such as inorganic or polymeric particles, in the composite coating. Without being bound by theory, the hydrophobic and hydrophilic regions and/or topographical bumps may increase efficiency of water collection, in particular in conditions when the atmospheric humidity is low or the temperature differential between surface and air is low.

The hydrophobic and hydrophilic regions and/or topographical bumps may be in a regular pattern on the surface of the composite coating. They may be in a random arrangement on the surface of the composite coating. The density of topographical bumps on a surface of the composite coating may be from about 0.1 to about 20 bumps per mm² of the surface, or it may be from about 0.1 to about 10, about 0.1 to about 5, about 0.2 to about 10, about 0.5 to about 10, about 1 to about 10, about 0.2 to about 5, about 0.5 to about 5, or about 1 to about 5 bumps per mm² of the surface. It may be, for example, about 0.1, 0.2, 0.5, 0.6, 0.7, 0.8, 0.9, 1, 1.1, 1.2, 1.5, 2, 2.1, 2.2, 2.5, 3, 3.5, 4, 4.5, 5, 6, 7, 8, 9, 10, 11, 12, 15, or 20 bumps per mm² of the surface.

The percentage area of hydrophilic regions relative to the total surface area of the surface may be from about 0% to about 20%, or it may be in an amount of from about 1% to about 20%, about 2% to about 20%, about 5% to about 20%, about 10% to about 20%, about 1% to about 10%, about 2% to about 10%, about 5% to about 10%, or about 5% to about 15%. It may, for example, be about 0, 1, 2, 3, 4, 5, 6, 7, 8, 9, 10, 11, 12, 15, or 20% relative to the total surface area of the surface.

The percentage area of hydrophobic regions relative to the total surface area of the surface may be from about 80% to about 99.9%, or it may be in an amount of from about 85% to about 99.9%, about 90% to about 99.9%, about 95% to about 99.9%, about 97% to about 99.9%, about 80% to about 99.5%, about 80% to about 99%, about 80% to about 97%, about 80% to about 95%, about 80% to about 90%, or about 85% to about 95%. It may, for example, be about 80, 81, 82, 83, 84, 85, 86, 87, 88, 89, 90, 91, 92, 93, 94, 95, 96, 97, 98, 99, 99.5, or 99.9% relative to the total surface area of the surface.

The hydrophilic regions on the surface may have a mean diameter of from about 0.1 µm to about 500 µm, about 0.1 µm to about 200 µm, about 0.1 µm to about 100 µm, about 0.1 µm to about 50 µm, about 0.1 µm to about 20 µm, about 0.2 µm to about 500 µm, about 0.5 µm to about 500 µm, about 1 µm to about 500 µm, about 1 µm to about 250 µm, about 1 µm to about 200 µm, about 1 µm to about 100 µm, about 1 µm to about 50 µm, about 1 µm to about 20 µm, 1 µm to about 10 µm, or about 2 µm to about 8 µm. It may have a mean diameter of, for example, about 0.1, 0.2, 0.5, 0.6, 0.7, 0.8, 0.9, 1, 2, 3, 4, 5, 6, 7, 8, 9, 10, 11, 12, 15, 20, 30, 40, 50, 60, 70, 80, 90, 100, 200, 300, 400, or 500 µm.

The topographical bumps on the surface may have a mean diameter of from about 0.1 µm to about 1000 µm, about 0.1 µm to about 500 µm, about 0.1 µm to about 200 µm, about 0.1 µm to about 100 µm, about 0.1 µm to about 50 µm, about 0.1 µm to about 20 µm, about 0.2 µm to about 500 µm, about 0.5 µm to about 500 µm, about 1 µm to about 500 µm, about 1 µm to about 250 µm, about 1 µm to about 200 µm, about 1 µm to about 100 µm, about 1 µm to about 50 µm, about 1 µm to about 20 µm, 1 µm to about 10 µm, or about 2 µm to about 8 µm. It may have a mean diameter of, for example, about 0.1, 0.2, 0.5, 0.6, 0.7, 0.8, 0.9, 1, 2, 3, 4, 5, 6, 7, 8, 9, 10, 11, 12, 15, 20, 30, 40, 50, 60, 70, 80, 90, 100, 200, 300, 400, 500 or 1000 µm.

Without being bound by theory, the hydrophilic and hydrophobic regions and or topographical bumps on a surface of the composite coating may facilitate the nucleation of water droplets from humid air (RH 10-100%) so as to increase the efficiency of water collection from atmospheric condensation on the surface.

The skilled person will understand that although the present specification describes the composite coating for collecting atmospheric water, that the present disclosure is not limited to the collection of water, and may be suitable for the collection of other liquids from vapours that are capable of condensing on a surface. For example, the composite coating of the present disclosure may be useful in more efficiently condensing alcohol from alcohol vapour in, for example, a distillation process, or of perfluorinated solvents in cooling apparatuses.

The skilled person will understand that the composite coating may be applied to a surface of the substrate by any deposition method. The composite coating may, for example, be applied to a surface of the substrate by painting with a brush, roller, or sprayer. It may, for example, be printed or dip coated onto a surface of the substrate. If the coating is to be applied onto a metal based substrate or some other substrate where poor adhesion of the composite coating to the substrate may be an issue, it may be necessary to apply a primer or adhesion layer on top of the substrate, and then apply the composite coating on top of the primer or adhesion layer, so that the composite coating is able to strongly bond to the substrate and/or protect the substrate from, for example, corrosion. Such primer or adhesion layers may, for example, include one or more anti-corrosion agent.

The primer may comprise one or more of acrylic, epoxy and polyurethane polymer, anticorrosion agents or pigment, reflective pigment, IR emitter (for example SiC and Si₃N₄) and adhesion promoting additives. The primer may comprise cured epoxy based polymer. The primer may comprise TiO₂ to substantially increase reflectivity.

The one or more anti-corrosion agents may prevent corrosion of the substrate, in particular when the substrate is a metal substrate. The one or more anti-corrosion agents may, for example, comprise zinc phosphate. The one or more anti-corrosion agents may be present in an amount of from about 0.01% to about 5% w/w in relation to the total mass of the composite coating, or it may be from about 0.01% to about 4%, about 0.01% to about 3%, about 0.01% to about 2%, about 0.01% to about 1%, about 0.1% to about 5%, about 0.2% to about 5%, about 0.5% to about 5%, about 1% to about 5%, about 0.1 % to about 4%, about 0.1% to about 3%, about 0.1% to about 2%, or about 0.01% to about 1% w/w in relation to the total mass of the composite coating. They may be, for example, present in an amount of about 0.01, 0.02, 0.05, 0.1, 0.2, 0.3, 0.4, 0.5, 0.6, 0.7, 0.8, 0.9, 1, 1.5, 2, 3.5, 4, 4.5, or 5% w/w in relation to the total mass of the composite coating.

A 50 µm thick composite coating may reflect about 40% or more of electromagnetic radiation having a wavelength from about 700 nm to about 2500 nm which is incident upon said coating, or it may reflect about 45%, 50%, 55%, 65%, or 70% or more of electromagnetic radiation having a wavelength from about 700 nm to about 2500 nm which is incident upon said coating.

A 50 µm thick composite coating may reflect about 80% or more of electromagnetic radiation having a wavelength from about 280 nm to about 400 nm which is incident upon said coating, or it may reflect about 85%, 87%, 90%, 91% or 92% or more of electromagnetic radiation having a wavelength from about 280 nm to about 400 nm which is incident upon said coating.

A 50 µm thick composite coating may reflect about 80% or more of electromagnetic radiation having a wavelength from about 400 nm to about 700 nm which is incident upon said coating, or it may reflect about 85%, 87%, 90%, 91% or 92% or more of electromagnetic radiation having a wavelength from about 400 nm to about 700 nm which is incident upon said coating.

### Hydrophobic Polymer

The hydrophobic polymer may comprise one or more different hydrophobic polymers. It may comprise one or more polymers selected from the group consisting of fluoropolymers and organosiloxanes. It may, for example, comprises a fluoropolymer, an organosiloxane, or a blend thereof. The fluoropolymer may comprise one or more selected from the group consisting of PTFE, PFA, FEP, ETFE, PVDF, ECTFE, PCTFE, PFSA, PFPE, PVDF-HFP, and copolymers and combinations thereof. The fluoropolymer may comprise a copolymer. The hydrophobic polymer may, for example, comprise PVDF-HFP, PDMS, or a blend thereof.

The weight average molecular weight of the hydrophobic polymer may be from about 2 kDa to about 500 kDa, or it may be from about 2 kDa to about 200 kDa, about 2 kDa to about 100 kDa, about 2 kDa to about 50 kDa, about 2 kDa to about 20 kDa, about 5 kDa to about 500 kDa, about 10 kDa to about 500 kDa, about 20 kDa to about 500 kDa, about 10 kDa to about 100 kDa, about 100 kDa to about 400 kDa, or about 10 kDa to about 50 kDa. It may be, for example, about 2, 5, 10, 12, 14, 15, 16, 18, 20, 25, 30, 40, 50, 60, 80, 100, 200, 300, 400, or 500 kDa.

The hydrophobic polymer may be present in the composite coating in an amount of from about 30% to about 99.5% w/w relative to the total mass of the composite coating, or it may be in an amount of from about 35% to about 99.5%, about 40% to about 99.5%, about 45% to about 99.5%, about 50% to about 99.5%, about 55% to about 99.5%, about 60% to about 99.5%, about 70% to about 99.5%, about 80% to about 99.5%, about 90% to about 99.5%, about 30% to about 99%, about 30% to about 95%, about 30% to about 90%, about 30% to about 85%, about 30% to about 80%, about 50% to about 85%, about 60% to about 85%, about 70% to about 85%, or about 80% to about 85% w/w relative to the total mass of the composite coating. It may, for example, be in an amount of about 20, 25, 30, 35, 40, 45, 50, 55, 60, 65, 70, 75, 80, 85, 90, 95, 99, or 99.5% relative to the total mass of the composite coating.

In the case where the fluoropolymer comprises PVDF-HFP, the PVDF-HFP may comprise from about 5% to about 50% of HFP by weight relative to the total weight of PVDF-HFP in the composite coating, or it may comprise from about 10% to about 50%, about 15% to about 50%, about 20% to about 50%, about 30% to about 50%, about 40% to about 50%, about 5% to about 40%, about 5% to about 30%, about 5% to about 20%, about 10% to about 50%, about 10% to about 40%, about 10% to about 30%, about 10% to about 20%, about 20% to about 40%, about 20% to about 30%, or about 5% to about 35% of HFP by weight relative to the total weight of PVDF-HFP in the composite coating. It may comprise, for example, about 5, 10, 15, 20, 25, 30, 35, 40, or 50% of HFP by weight relative to the total weight of PVDF-HFP in the composite coating.

The weight average molecular weight of the fluoropolymer may be from about 2 kDa to about 500 kDa, or it may be from about 2 kDa to about 200 kDa, about 2 kDa to about 100 kDa, about 2 kDa to about 50 kDa, about 2 kDa to about 20 kDa, about 5 kDa to about 500 kDa, about 10 kDa to about 500 kDa, about 20 kDa to about 500 kDa, about 10 kDa to about 100 kDa, about 100 kDa to about 400 kDa, or about 10 kDa to about 50 kDa. It may be, for example, about 2, 5, 10, 12, 14, 15, 16, 18, 20, 25, 30, 40, 50, 60, 80, 100, 200, 300, 400, or 500 kDa.

The fluoropolymer may be present in the composite coating in an amount of from about 30% to about 99.5% w/w relative to the total mass of the composite coating, or it may be in an amount of from about 35% to about 99.5%, about 40% to about 99.5%, about 45% to about 99.5%, about 50% to about 99.5%, about 55% to about 99.5%, about 60% to about 99.5%, about 70% to about 99.5%, about 80% to about 99.5%, about 90% to about 99.5%, about 30% to about 99%, about 30% to about 95%, about 30% to about 90%, about 30% to about 85%, about 30% to about 80%, about 50% to about 85%, about 60% to about 85%, about 70% to about 85%, or about 80% to about 85% w/w relative to the total mass of the composite coating. It may, for example, be in an amount of about 20, 25, 30, 35, 40, 45, 50, 55, 60, 65, 70, 75, 80, 85, 90, 95, 99, or 99.5% relative to the total mass of the composite coating.

### Hydrophilic Substance

The hydrophilic substance may be selected from the group consisting of inorganic particles, hydrophilic polymers, and combinations and composites thereof.

In the case where the hydrophilic substance comprises inorganic particles, the inorganic particles may have a hydrophilic surface. The core of the inorganic particles may be hydrophilic, or hydrophobic. The inorganic particles may be coated with a surface modifying agent to make their surface hydrophilic. The surface modifying agent may be inorganic, or it may be organic. The inorganic particles may, for example, comprise silica particles.

In the case where the inorganic particles comprise silica particles, the silica particles may comprise silica nano/micro-particles. The silica particles may be polydisperse or monodisperse. The silica particles may act to increase scattering and reflection in the UV-vis electromagnetic spectrum range, increase emission in the Mid-IR electromagnetic spectrum and/or to induce hydrophilic patches and/or bumps on a surface of the composite coating.

The silica nano/micro-particles may have a mean diameter of from about 0.25 µm to about 100 µm, about 0.25 µm to about 50 µm, about 0.25 µm to about 20 µm, about 0.5 µm to about 100 µm, about 1 µm to about 100 µm, about 1 µm to about 100 µm, about 1 µm to about 50 µm, about 1 µm to about 20 µm, 1 µm to about 10 µm, or about 2 µm to about 8 µm. It may have a mean diameter of, for example, about 0.25, 0.5, 0.6, 0.7, 0.8, 0.9, 1, 2, 3, 4, 5, 6, 7, 8, 9, 10, 11, 12, 15, 20, 30, 40, 50, 60, 70, 80, 90, or 100 µm.

In the case where the silica nano/micro-microparticles are polydisperse, the silica microspheres may have a diameter of from about 0.1 µm to about 100 µm, about 0.1 µm to about 50 µm, about 0.1 µm to about 20 µm, about 0.2 µm to about 100 µm, about 0.5 µm to about 100 µm, about 1 µm to about 100 µm, about 1 µm to about 100 µm, about 1 µm to about 50 µm, or about 1 µm to about 20 µm.

The size of the silica nano/micro-particles may be determined by laser diffraction.

In the case where the hydrophilic substance comprises hydrophilic polymers, the hydrophilic polymers may comprise polyacrylates, PMMA, PVA, PEG, and copolymers and combinations thereof. The hydrophilic polymers may comprise copolymers. The hydrophilic polymers may be in the form of microspheres. The microspheres may, for example, have a hydrophobic core and a hydrophilic surface. They may be, for example, hydrophilic surface modified polystyrene beads.

The weight average molecular weight of the hydrophilic polymers may be from about 2 kDa to about 500 kDa, or it may be from about 2 kDa to about 200 kDa, about 2 kDa to about 100 kDa, about 2 kDa to about 50 kDa, about 2 kDa to about 20 kDa, about 5 kDa to about 500 kDa, about 10 kDa to about 500 kDa, about 20 kDa to about 500 kDa, about 10 kDa to about 100 kDa, or about 10 kDa to about 50 kDa. It may be, for example, about 2, 5, 10, 12, 14, 15, 16, 18, 20, 25, 30, 40, 50, 60, 80, 100, 200, 300, 400, or 500 kDa.

The hydrophilic substance may be present in the composite coating in an amount of from about 0.1% to about 70% w/w relative to the total mass of the composite coating, or it may be in an amount of from about 0.1% to about 50%, about 0.2% to about 50%, about 0.5% to about 50%, about 1% to about 50%, about 5% to about 50%, about 1% to about 40%, about 1% to about 30%, about 1% to about 20%, or about 5% to about 20% w/w relative to the total mass of the composite coating. It may, for example, be in an amount of about 0.1, 0.2, 0.5, 1, 2, 3, 4, 5, 6, 7, 8, 9, 10, 11, 12, 13, 14, 15, 20, 25, 30, 35, 40, 45, 50, 60, or 70% relative to the total mass of the composite coating.

### Substrate

The substrate may be any object or surface of an object. It may be any object where cooling one or more surfaces provides an advantage. It may be an object where water collection and/or increased condensation, optionally increased atmospheric condensation may be an advantage. Typically the substrate may be an external surface of an object that is exposed to the sky. It may be an external surface of a building material. It may, for example, be a roof. The substrate may be made of any material. It may, for example, comprise wood, glass, paper, textile, cement, concrete, plastic, metal, ceramic, composite materials, organic materials, inorganic materials, or a combination thereof. The substrate may be rigid, or it may be flexible. In certain embodiments, the substrate may be, for example, a flexible polymer sheet, mesh, or net. In certain embodiments, the composite coating itself may be the substrate. That is, the coating may be a self-supporting structure.

The skilled person will understand that the substrate may have any topography. For example, the substrate may have a substantially flat surface on which the composite coating may be applied. Alternatively, the substrate may have a rough surface, or an uneven surface which may be coated with the composite coating. The surface of the substrate may be a bumpy surface.

The substrate may have a coatable surface area (that is, the surface area of the substrate which can be coated with the composite coating) of about 10 cm² or more, about 20 cm² or more, about 50 cm² or more, about 100 cm² or more, about 200 cm² or more, about 500 cm² or more, about 1000 cm² or more, about 2000 cm² or more, about 5000 cm² or more, about 1 m² or more, about 2 m² or more, about 5 m² or more, about 10 m² or more, about 20 m² or more, about 50 m² or more, or about 100 m² or more. It may have a coatable surface area of from about 10 cm² to about 5000 m², or about 20 cm² to about 5000 m², about 50 cm² to about 5000 m², about 100 cm² to about 5000 m², about 200 cm² to about 5000 m², about 500 cm² to about 5000 m², about 1000 cm² to about 5000 m², about 2000 cm² to about 5000 m², about 5000 cm² to about 5000 m², about 1 m² to about 5000 m², about 2 m² to about 5000 m², about 5 m² to about 5000 m², about 10 m² to about 5000 m², about 20 m² to about 5000 m², about 50 m² to about 5000 m², or about 100 m² to about 5000 m². It may have a coatable surface area of about 10 cm², 20 cm², 50 cm², 100 cm², 200 cm², 500 cm², 1000 cm², 2000 cm², 5000 cm², 1 m², 2 m², 5 m², 10 m², 20 m², 50 m², 100 m², 200 m², 500 m², 1000 m², 2000 m², or 5000 m².

### A Method for Increasing Collection of Atmospheric Water on a Surface of a Substrate

Disclosed herein is a method for increasing atmospheric condensation on a surface of a substrate, comprising coating the substrate with the composite coating as hereinbefore described and exposing the coated substrate to the sky. The substrate may be as hereinbefore described.

In certain embodiments the method does not require use of an external power source, such as power from an energy grid and/or renewable power, e.g. solar/wind power to collect atmospheric water. Alternatively, or additionally, the method requires no moving parts, such as fans, in order to be performed.

The method may be a method for cooling a surface of the substrate. The composite coating may be capable of cooling a surface of the substrate to an average temperature of from about 0.1° C. to about 10° C., or from about 0.2° C. to about 10° C., about 0.5° C. to about 10° C., about 1° C. to about 10° C., about 1° C. to about 5° C., or about 0.1° C. to about 2° C., below ambient temperature over a 12 hour daylight period (under conditions where the day has an average ambient temperature of about 20° C., a temperature range of from about 15° C. to about 25° C., an average relative humidity of about 50, and a relative humidity range of from about 20 to about 80). It may, for example, be capable of cooling a surface of the substrate to an average temperature of about 0.1, 0.2, 0.5, 0.6, 0.7, 0.8, 0.9, 1, 1.1, 1.2, 1.3, 1.4, 1.5, 1.6, 1.7, 1.8, 1.9, 2, 3, 4, 5, 6, 7, 8, 9, or 10° C., below ambient temperature over a 12 hour daylight period (under conditions where the day has an average ambient temperature of about 20° C., a temperature range of from about 15° C. to about 25° C., an average relative humidity of about 50, and a relative humidity range of from about 20 to about 80).

The composite coating may be capable of cooling a surface of the substrate to an average temperature of from about 0.1° C. to about 10° C., or from about 0.2° C. to about 10° C., about 0.5° C. to about 10° C., about 1° C. to about 10° C., about 1° C. to about 5° C., about 1° C. to about 3° C., or about 0.1° C. to about 2° C., below ambient temperature over a 12 hour night time period (under conditions where the night has an average ambient temperature of about 10° C., a temperature range of from about 5° C. to about 15° C., an average relative humidity of about 50, and a relative humidity range of from about 20 to about 80). It may, for example, be capable of cooling a surface of the substrate to an average temperature of about 0.1, 0.2, 0.5, 0.6, 0.7, 0.8, 0.9, 1, 1.1, 1.2, 1.3, 1.4, 1.5, 1.6, 1.7, 1.8, 1.9, 2, 3, 4, 5, 6, 7, 8, 9, or 10° C., below ambient temperature over a 12 hour night time period (under conditions where the night has an average ambient temperature of about 10° C., a temperature range of from about 5° C. to about 15° C., an average relative humidity of about 50, and a relative humidity range of from about 20 to about 80).

The method may be a method for collecting atmospheric water, the method comprising a step of exposing the coated substrate to the sky, under atmospheric conditions having a relative humidity of about 30% or more, to condense atmospheric water on the coated substrate; and collecting the condensed atmospheric water.

The composite coating may increase the atmospheric water condensation collection on a surface, when compared with an uncoated surface, over a 24 hour day period (under conditions where the day has an average ambient temperature of about 15° C., a temperature range of from about 5° C. to about 25° C., an average relative humidity of about 50, and a relative humidity range of from about 20 to about 80), by from about 0.01 L per square metre of the surface to about 2 L/m², or from about 0.01 L/m² to about 1.5 L/m², about 0.01 L/m² to about 1 L/m², about 0.01 L/m² to about 0.5 L/m², about 0.1 L/m² to about 2 L/m², about 0.1 L/m² to about 1.5 L/m², about 0.1 L/m² to about 1 L/m², about 0.1 L/m² to about 0.5 L/m², or about 0.5 L/m² to about 2 L/m². It may, for example, increase the atmospheric water condensation collection on a surface, when compared with an uncoated surface, over a 24 hour day period (under conditions where the day has an average ambient temperature of about 15° C., a temperature range of from about 5° C. to about 25° C., an average relative humidity of about 50, and a relative humidity range of from about 20 to about 80), by about 0.01, 0.02, 0.05, 0.1, 0.2, 0.5, 0.6, 0.7, 0.8, 0.9, 1, 1.1, 1.2, 1.3, 1.4, 1.5, 1.6, 1.7, 1.8, 1.9, or 2 L/m².

The composite coating may increase the atmospheric water condensation collection on a surface, when compared with an uncoated surface, over a 24 hour/day period (under conditions where the night has an average ambient temperature of about 10° C., a temperature range of from about 5° C. to about 15° C., an average relative humidity of about 50, and a relative humidity range of from about 20 to about 80), by from about 0.01 L per square metre of the surface per day to about 2 L/m² per day, or from about 0.01 L/m² to about 1.5 L/m² per day, about 0.01 L/m² to about 1 L/m² per day, about 0.01 L/m² to about 0.5 L/m² per day, about 0.1 L/m² to about 2 L/m² per day, about 0.1 L/m² to about 1.5 L/m² per day, about 0.1 L/m² to about 1 L/m² per day, about 0.1 L/m² to about 0.5 L/m² per day, or about 0.5 L/m² to about 2 L/m² per day. It may, for example, increase the atmospheric water condensation collection on a surface, when compared with an uncoated surface, over a 24 hour/day period (under conditions where the night has an average ambient temperature of about 10° C., a temperature range of from about 5° C. to about 15° C., an average relative humidity of about 50, and a relative humidity range of from about 20 to about 80), by about 0.01, 0.02, 0.05, 0.1, 0.2, 0.5, 0.6, 0.7, 0.8, 0.9, 1, 1.1, 1.2, 1.3, 1.4, 1.5, 1.6, 1.7, 1.8, 1.9, or 2 L/m² per day.

### A Method for Producing a Composite Coating

Disclosed herein is a method for producing a composite coating, comprising mixing a hydrophobic polymer and a solvent together to form a mixture, wherein the solvent is capable of at least partially dissolving the hydrophobic polymer; and adding a non-solvent to the mixture to form a composite coating, wherein the hydrophobic polymer is insoluble, or only slightly soluble in the non-solvent; and wherein the composite coating comprises a plurality of voids. The composite coating and/or hydrophobic polymer may be as hereinbefore described.

The method may further comprise a step of adding a hydrophilic substance to the mixture. The hydrophilic substance may be as hereinbefore described.

The method may further comprise a step of adding one or more surface modifying agents selected from the group consisting of PDMS, polyurethane, PVDF, PMMA, polystyrene, and silanes to the mixture. Alternatively, or additionally, the one or more surface modifying agents may form an outer layer of the composite coating. The one or more surface modifying agents may be as hereinbefore described.

The method may include a step of phase inversion of the hydrophobic polymer as a technique for producing a composite coating with a high portion of micro-sized and nano-sized air voids. This self-assembly process may exploit the demixing of the hydrophobic polymer in solution in the solvent with the addition of the non-solvent. The addition of the non-solvent to the hydrophobic polymer solution may lead to phase separation into a hydrophobic polymer-rich and a hydrophobic polymer-lean phase.

The method may comprise applying the composite coating to a substrate, and removing at least a portion of the solvent and/or non-solvent from the composite coating. The removing may be, for example, by evaporation. The method may, for example comprise painting the composite coating onto a substrate and allowing the composite coating to substantially dry.

The skilled person will understand that the composite coating may be applied to a surface of the substrate by any deposition method. The composite coating may, for example, be applied to a surface of the substrate by painting with a brush, roller, or sprayer. It may, for example, be printed or dip coated onto a surface of the substrate. If the coating is to be applied onto a metal based substrate or some other substrate where poor adhesion of the composite coating to the substrate may be an issue, it may be necessary to apply a primer or adhesion layer on top of the substrate, and then apply the composite coating on top of the primer or adhesion layer, so that the composite coating is able to strongly bond to the substrate and/or protect the substrate from, for example, corrosion.

A surface of the composite coating may comprise hydrophobic and hydrophilic regions and/or topographical bumps. The hydrophobic and hydrophilic regions and/or topographical bumps may form when the composite coating is applied to the substrate. Alternatively, the mixture, after addition of the non-solvent, may be applied to the substrate to form a film thereon, and the film may thereafter be treated to form the hydrophobic and hydrophilic regions and/or topographical bumps. The post-application treatment may include, for example, the addition of particles, plasma activation, chemical vapor deposition, polymer film dewetting, lubricant infusion, or a combination thereof.

It will be understood that the invention disclosed and defined in this specification extends to all alternative combinations of two or more of the individual features mentioned or evident from the text or drawings. All of these different combinations constitute various alternative aspects of the invention.

### EXAMPLES

The examples disclosed herein are discussed to illustrate application of the present disclosure and should not be construed as limiting the present disclosure in any way.

### Example 1: Composite Coating for Collecting Condensed Atmospheric Water

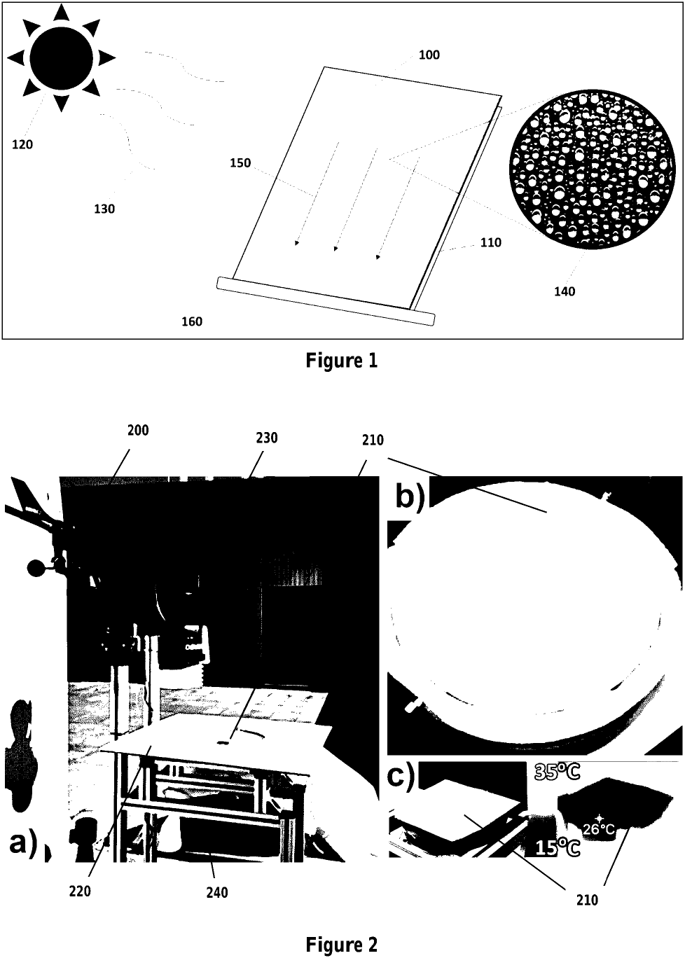

An example composite coating used for collecting atmospheric water is shown in FIG. 1. The composite coating is able to passively cool and collect atmospheric water without the need for an external power source. The composite coating 100 is applied to a sloped substrate 110, such as a roof. When the composite coating 100 is exposed to daylight conditions, including sunlight from the sun 120, and atmospheric humidity 130, the combination of the voids and optional reflective additives in the composite coating spontaneously cool the substrate surface when compared with a substrate surface which has not been coated with the composite coating.

The atmospheric water condenses onto the cooled surface of the composite coating. The surface of the composite coating 100 enables condensed water droplet formation on the surface of the composite coating 100 as shown in the expanded view 140. As the water droplets reach a critical volume where they are too large to remain in place, the slope of the substrate 100 allows them to drain 150 into a collection vessel 160. The composite coating may enable collection of up to about 2 L of water per square meter of surface per day.

### Example 2: Composite Coating Formation and Measurement of Cooling and Reflective Properties

### Materials

### Polymer

PVDF-HFP pellets or powder (having HFP content 5-35%, and various weight average molecular weights) were used as the main hydrophobic polymer in the example composite coatings.

### Solvents

Acetone, 1,3 dioxolane, and tetrahydrofuran were used as solvent for the preparation of precursor solutions of PVDF-HFP. Deionised water (Millipore) was used as a non-solvent for triggering phase inversion of the PVDF-HFP solutions.

### Additives

In certain embodiments, polydisperse silica particles (2 - 19 µm, median diameter = 4 - 8 µm) or monodisperse silica particles (dₘₑₐₙ= 0.25, 0.4, 0.8, or 4.7 µm) were used for the purpose of improving the spectroscopic properties of the dry composite coating. In certain embodiments, organosilane or silicone modified polymers were used to facilitate bonding to different types of substrates. In certain embodiments, poly (methyl methacrylate) (PMMA) was used in substitution of PVDF-HFP up to 30% in mass to realise a substantial change in composite coating surface morphology. In certain embodiments, N-Methyl-2-pyrrolidone (NMP) was used as a solvent quality regulator to control the degree of phase inversion and extend shelf life of the precursor solution. The additives mentioned above were introduced in the liquid composite coating, prior to applying the liquid composite coating to a surface.

In certain embodiments, polyurethane, PVDF, PMMA, polystyrene (PS) and/or PDMS polymers in aqueous dispersion form (i.e. polymer emulsion) were used as a top coating material for the purpose of surface modification as well as a mechanical protection layer for the composite coatings. They were applied onto the dry composite coating, forming a multi-layered structure. In certain embodiments, octadecyl trichlorosilane (OTS, as well as other silanes) was used for hydrophobising a surface of the composite coatings, and facilitating the detachment of water droplets to be collected at the surface.

In certain embodiments, a primer coating consisting of acrylic, epoxy or polyurethane polymer, anticorrosion pigment, reflective pigment, IR emitter (SiC, Si₃N₄) and adhesion promoting additives could be applied on the substrate prior to the liquid composite coating. Use of a primer broadened the scope of suitable substrates for application, enhanced durability and weatherability, as well as enhancing the reflectance of visible electromagnetic radiation (λ = 400 - 700 nm).

### Liquid Composite coating Preparation

Measured amounts of PVDF-HFP powder as well as additives of interest were dispersed in pure acetone at 50° C. by constantly stirring for 45 minutes, followed by dropwise addition of deionised water. The mass ratio of polymer, solvent and non-solvent were 10:80:10 respectively, with minor adjustments if required. The additives were used in 1% by weight or less relative to the total weight of the liquid composite coating. The mixture was further stirred at 50° C. for 45 minutes, and then removed from heat and degassed by sonication for 5 minutes. In the case of PVDF-HFP pellets, the polymer was mixed with pure acetone in a round bottom flask and refluxed at 80° C. using a water bath with constant stirring for 2 hours, followed by dropwise addition of deionised water. The mixture was further stirred under reflux at 80° C. using a water bath for 2 hours, then removed from heat and degassed by sonication for 5 minutes. The liquid composite coating was stored in a 20 mL container at 50° C., and cooled to room temperature by equilibrating to ambient environment for 1 hour before use.

### Coating Surfaces With the Liquid Composite Coating

Wet films at various thickness up from 100 micrometres to 1 mm were formed by spreading the liquid composite coating using an adjustable blade applicator over a flat plate (glass, metals or other materials could be used as support). Higher thickness up to 5 mm was achieved by pouring the liquid composite coating into a Teflon mould. The applied liquid composite coating was then allowed to dry and inspected after 7 days of complete drying. The liquid composite coating could also be applied to surfaces by dipping or by using a brush or a roller. After drying completely, about 10% pbw original mass of the liquid composite coating remained and formed the composite coating, whereas about 90% pbw volatile components evaporated leaving the composite coating with air voids.

### Properties of the Composite Coating Applied to a Surface

In embodiments, the composite coating comprised the following layers:
A cooling layer, which was a 50 - 500 µm thick layer comprising the porous PVDF-HFP matrix, additional polymer (i.e. PMMA), additives (e.g. organosilane), and emissive particles (e.g. SiO₂ microspheres).
An optional surface layer, which was an up to 50 µm thick layer comprising hydrophobic polymer in a non-porous continuous phase (e.g. PDMS), with surface chemical patterns comprising hydrophilic and hydrophobic regions. This layer was applied onto the dried cooling layer in liquid form and allowed to cure. Commercially available polyurethane emulsion, or PVDF emulsion, or two component cross-linkable PDMS were used.
In certain embodiments, an optional primer layer below the cooling layer, which was 25 - 75 µm in thickness was applied. This layer comprised one or more of anti-corrosive pigment, reflective pigment, IR emitter, and polymer. Commercially available epoxy primer may be suitably utilised.

When the coating was employed on a substrate where adhesion or long term durability could potentially be a problem, a primer layer was also used below the cooling layer (i.e. between the metal substrate and the cooling layer.

### Results

Estimates of water collection rates in different parts of Australia were made based on weather data mined from the Australian Bureau of Meteorology. The quality of the collected water was assessed and the composite coating was found to be suited for use in number of areas. The quality of the water collected using the composite coating could be further improved by using UV lamps to sterilise the stored water after collection.

### Cooling Performance Results

A prototype coating was applied onto an aluminium substrate, and placed on the roof of a building with full access to open sky for several hours in a row. A custom built framework was used to mount the coating and record temperature data. The surfaces coated with the composite coating were observed to passively cool when exposed to the sky.

### Example 3: Composite Coating Demonstration 1. PVDF-HFP Only on an Aluminium Sheet Substrate

### Materials

Composition of liquid composite coating: 10% (wt. %) PVDF-HFP powder (HFP portion 20%-35% wt.%); 80% (wt. %) acetone; and 10% (wt. %) deionised water.

### Liquid Composite Coating Preparation

The PVDF-HFP polymer was mixed in pure acetone at 50° C. by constantly stirring for 45 minutes, followed by dropwise addition of deionised water. The mixture was further stirred at 50° C. for 45 minutes, and then removed from heat and degassed by sonication for 5 minutes. The precursor solution was stored in a 20 mL container at 50° C.

### Substrate Preparation

Aluminum Alloy 1100 sheet was used as the substrate. The aluminum sheet was cut into approx. 25 cm × 30 cm and 6 cm × 7 cm pieces. The substrates were sanded with P1200 sandpaper, and cleaned with ethanol, then sonicated in 1% wt. sodium hydroxide aqueous solution for 15 minutes, then immersed in 1 molL⁻¹ iron (III) chloride solution for 7.5 minutes, and eventually immersed in gently boiling water for 30 minutes. This treatment ensured adhesion of the composite coating onto aluminum surface without the need of primer or adhesion promoter. The substrates were sonicated in ethanol and blow dried with high pressure nitrogen before use for coating.

### Coated Substrate Preparation

The liquid composite coating was sonicated for 5 minutes and then conditioned at ambient temperature for 30 minutes. An adjustable blade applicator was set to a 1 mm gap. 3 mL of liquid composite coating was deposited on the 6 cm × 7 cm treated aluminum substrate with a disposable syringe and then spread by the applicator to achieve a wet film of approximately 1 mm thick. Alternatively, when preparing composite coating for cooling assessment, approx. 60 mL of solution was deposited on the 25 cm × 30 cm treated aluminum substrate. The wet film was dried in an ambient environment (20-26° C. temperature and 40-70% relative humidity). The acetone and water was allowed to evaporate off the liquid composite coating in open air for 24 hours thereby forming the composite coating comprised of PVDF-HFP only.

### Composite Coating Film Characterisation

The dry film thickness was measured by a coating thickness gauge. The thickness was around 80 - 120 micrometer. The hemispherical spectral reflectance in UV/Visible/Near infrared range (0.3 - 2.5 µm) was measured by a spectrometer equipped with a PTFE integrating sphere. The hemispherical spectral reflectance in near to far infra-red range (6000 - 180 cm⁻¹) was measured by a Fourier-Transform-based spectrometer equipped with gold integrating sphere and a Deuterated Lanthanum α Alanine doped Tri-Glycine Sulphate detector with Caesium Iodide window. The spectral properties could demonstrate the passive cooling capability of the composite coating film. Scanning electron microscope was used to visualise surface and cross-sectional structure of the dry composite coating. Contact angle goniometer was used to characterise surface wettability of the composite coating.

### Passive Cooling Performance and Water Condensation

A custom-built experimental assembly including a weather station was used to assess the passive cooling performance of composite coatings under open sky conditions. FIG. 2(a) is a photograph of the assembly, including weather station 200 which captured ambient temperature, humidity, wind speed, wind direction, solar irradiance, and cup to collect rainfall 230; computer and datalogger 240; and composite coating 210, surrounded by shield 220. FIG. 2(b) is a photograph of a composite coating 210 of 200 mm in diameter applied over an aluminium assembly which has thermocouple connections at four different points, wrapped by insulation film to minimise convective and conductive heat exchange with the surroundings. FIG. 2(c) are photographs taken with a regular camera (left hand) and IR camera (right hand) indicating the surface temperature of the composite coating 210 when exposed to the sky is significantly lower than that of the surroundings.

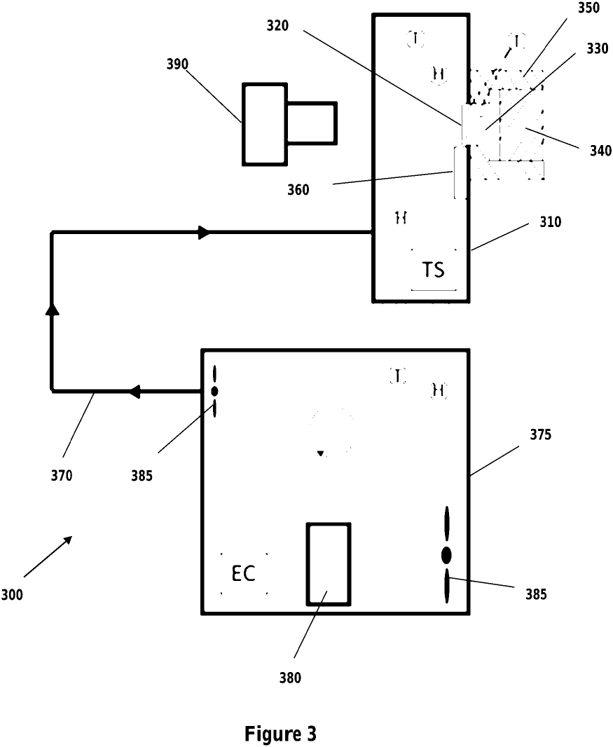

Another custom-built experimental assembly, including cooling module and an environmental chamber was used to assess water condensation onto the composite coating under laboratory conditions. FIG. 3 is a schematic diagram of the assembly 300. Test section 310 includes a sample of composite coating 320 mounted vertically on aluminium block 330 which in turn is in contact with Peltier module 340, which cools the aluminium block 330. The Peltier module and aluminium block are insulated with insulation 350. A cuvette 360 is positioned below the composite coating so as to collect condensed water which forms on the surface of the composite coating. The test section 310 is connected via line 370 to environmental chamber 375 which contains humidifier 380. In operation, fans 385 convey humidified air from the environmental section to the test section. Thermocouples (T) and humidity sensors (H) are placed in each of the test and environmental sections. High speed camera 390 is positioned to enable photographs of the composite coating to be obtained.

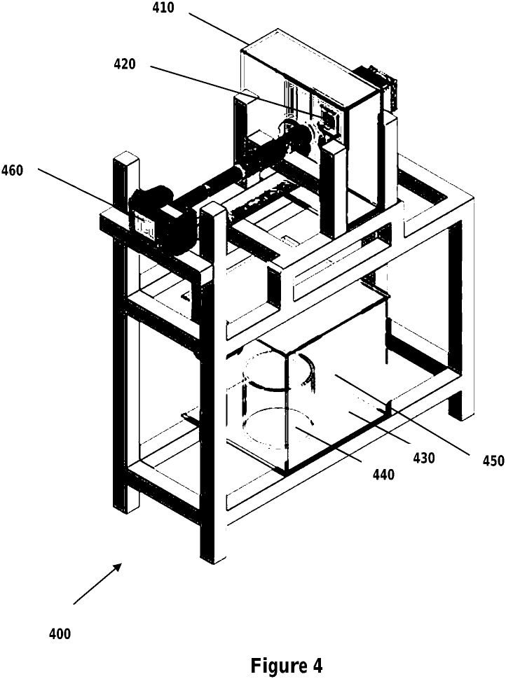

FIG. 4 is a 3-dimensional depiction of the assembly of FIG. 3. The assembly 400, contains test section 410 which includes a sample of composite coating 420 mounted vertically. The test section is connected to environmental chamber 430 which contains humidifier 440. In operation, fans 450 convey humidified air from the environmental section to the test section. High speed camera 460 is positioned to enable photographs of the composite coating to be obtained.

### Characterisation Results

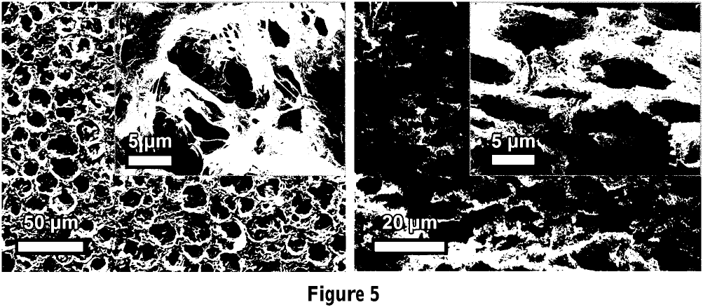

FIG. 5 (left) is a SEM micrograph of the porous surface of the composite film, inset: higher magnification showing the nanopores. FIG. 5 (right) is a SEM micrograph of the cross section of the composite film, inset: higher magnification showing the nanopores.

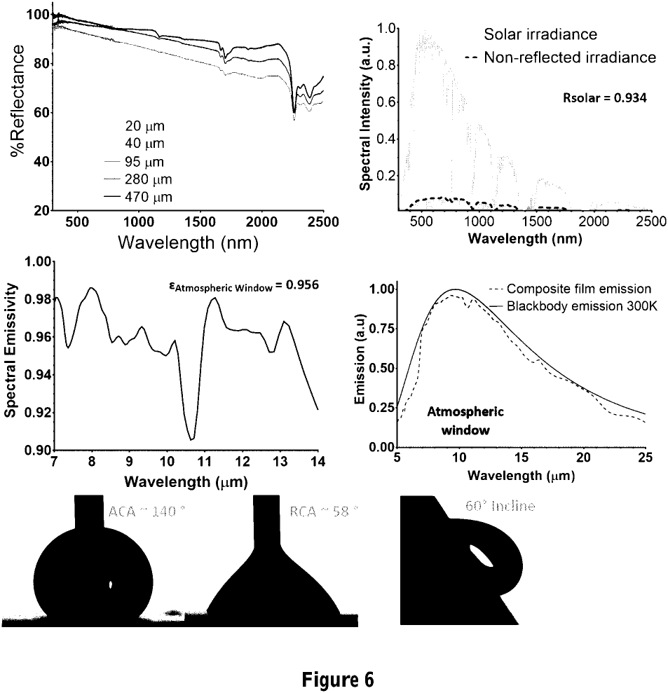

FIG. 6 (top left) illustrates the spectral reflectivity over solar wavelengths (λ = 0.3 -2.5 µm) of composite coatings at various film thicknesses (20 µm, 40 µm, 95 µm, 280 µm and 470 µm, from bottom to top).

FIG. 6 (top right) ASTM G173-03 Solar Spectrum Irradiance vs. non-reflected irradiance of an approx. 200 µm thick composite coating, with 0.934 total solar reflectance.

FIG. 6 (middle left) is the spectral emissivity over atmospheric window (λ = 8 - 13 µm) of approx. 100 µm thick composite coating.

FIG. 6 (middle right) is the blackbody radiation spectrum at 300 K vs. emission spectrum of composite coating approx. 100 µm thick, with 0.956 total atmospheric window emittance.

FIG. 6 (bottom left) is advancing contact angle (ACA) and receding contact angle (RCA) of water over the composite coating surface.

FIG. 6 (bottom right) depicts a 30 µL water droplet over a composite coating surface inclined at 60 o. It was observed that no roll-off of the water droplet occurred.

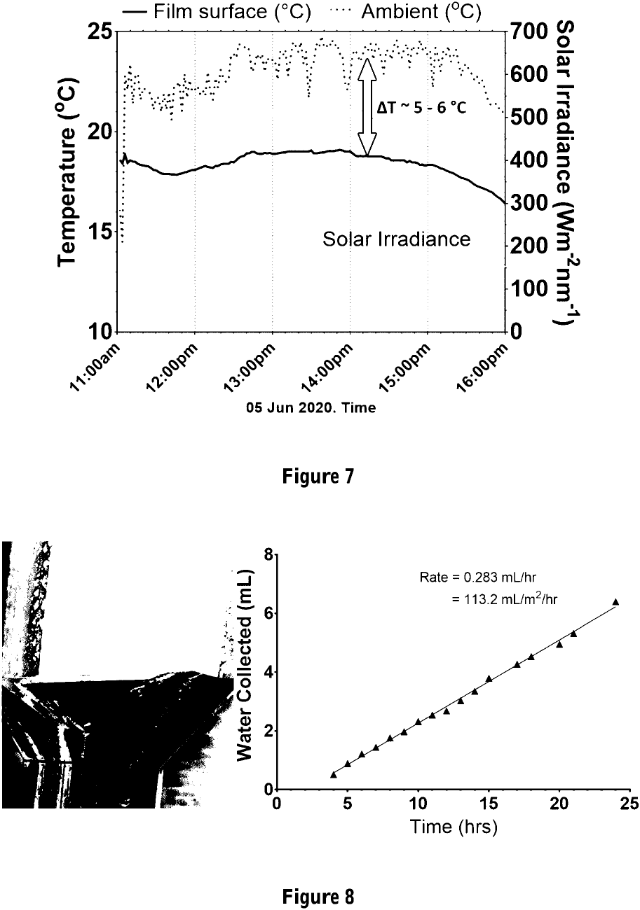

FIG. 7 depicts the surface temperature of composite coating vs. ambient temperature under open sky during daytime with the measured solar irradiance intensity shown in shading.

FIG. 8 (left) illustrates water droplets condensed on the surface of composite coating in laboratory condensation chamber at 10° C. below dew point and 85% relative humidity. FIG. 8 (right) illustrates water collected over time and rate of condensation was calculated to be 113.2 mL per m² per hour.

### Example 4: Composite Coating Demonstration 2. Reduced Surface Porosity PVDF-HFP/PMMA 7:3 composite coating on aluminium sheet substrate

### Materials

Composition of liquid composite coating: 7% (wt. %) PVDF-HFP powder (HFP portion 20%-35% wt.%); 3% (wt. %) PMMA; 80% (wt. %) acetone; and 10% (wt. %) deionised water.

### Liquid Composite Coating Preparation

The PVDF-HFP polymer and PMMA polymer were weighed into a suitable container and mixed in pure acetone at 50° C. by constantly stirring for 45 minutes, followed by dropwise addition of deionised water. The mixture was further stirred at 50° C. for 45 minutes, and then removed from heat and degassed by sonication for 5 minutes. The liquid composite coating was stored in a 20 mL container at 50° C.

### Substrate Preparation

Aluminum Alloy 1100 sheet was used as the substrate. The aluminum sheet was cut into approx. 25 cm × 30 cm and 6 cm × 7 cm pieces. The substrates were sanded with P1200 sandpaper, and cleaned with ethanol, then sonicated in 1% wt. sodium hydroxide aqueous solution for 15 minutes, then immersed in 1 molL⁻¹ iron (III) chloride solution for 7.5 minutes, and eventually immersed in gently boiling water for 30 minutes. This treatment ensured adhesion of the composite coating onto aluminum surface without the need of primer or adhesion promoter. The substrates were sonicated in ethanol and blow dried with high pressure nitrogen before use for coating.

### Composite Coating Film Preparation

The liquid composite coating was sonicated for 5 minutes and then conditioned at ambient temperature for 30 minutes. The casting of wet film was performed inside an atmosbag which was continuously purged with N₂ and kept below 10 % relative humidity. An adjustable blade applicator was set to a 1 mm gap. 3 mL of liquid composite coating was deposited on the 6 cm × 7 cm treated aluminum substrate with a disposable syringe and then spread by the applicator to get a wet film of approximately 1 mm thick. Alternatively, when preparing composite coating for cooling assessment, approx. 60 mL of liquid composite coating was deposited on the 25 cm × 30 cm treated aluminum substrate. The wet film was left inside the atmosbag for 15 minutes until a white colour developed, then transferred to an ambient environment (20-26° C. temperature and 40-70% relative humidity). The acetone and water were allowed to evaporate off the wet film in open air for 24 hours thereby forming a composite coating comprised of PVDF-HFP and PMMA only.

### Composite Coating Film Characterisation

The dry film thickness was measured by a coating thickness gauge. The thickness was around 80 - 120 micrometer. The hemispherical spectral reflectance in UV/Visible/Near infrared range (0.3 - 2.5 µm) was measured by a spectrometer equipped with a PTFE integrating sphere. The hemispherical spectral reflectance in near to far infra-red range (6000 - 180 cm-1) was measured by a Fourier-Transform-based spectrometer equipped with gold integrating sphere and a Deuterated Lanthanum α Alanine doped Tri-Glycine Sulphate detector with Caesium Iodide window. The spectral properties could demonstrate the passive cooling capability of the composite coating film. Scanning electron microscope was used to visualise surface and cross-sectional structure of the dry composite coating. Contact angle goniometer was used to characterise surface wettability of the composite coating.

### Characterisation Results

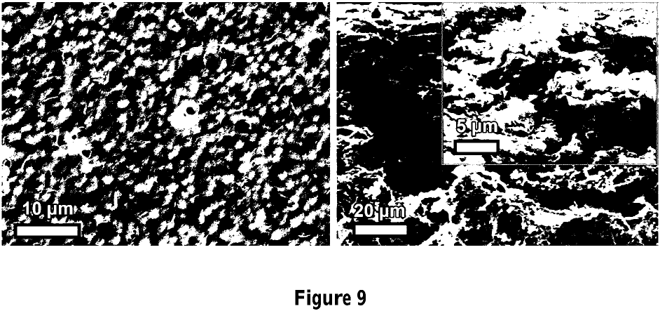

FIG. 9 (left hand) is a SEM micrograph of the surface of the composite film, and (right hand) a SEM micrograph of the cross section of the composite film. The inset is higher magnification showing the spherulitic crystal structure of polymer near the top surface.

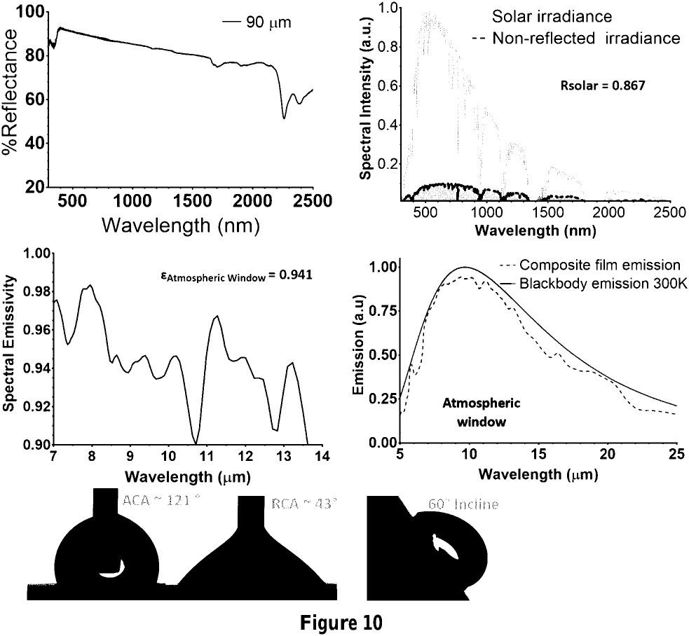

FIG. 10 (top left) illustrates spectral reflectivity over solar wavelengths (λ = 0.3 -2.5 µm) of composite coatings at approx. 90 µm thickness.

FIG. 10 (top right) is the ASTM G173-03 Solar Spectrum Irradiance vs. non-reflected irradiance of an approx. 90 µm thick composite coating, with 0.867 total solar reflectance.

FIG. 10 (middle left) is the spectral emissivity over atmospheric window (λ = 8 - 13 µm) of approx. 90 µm thick composite coating.

FIG. 10 (middle right) is the blackbody radiation spectrum at 300 K vs. emission spectrum of composite coating approx. 90 µm thick, with 0.941 total atmospheric window emittance.

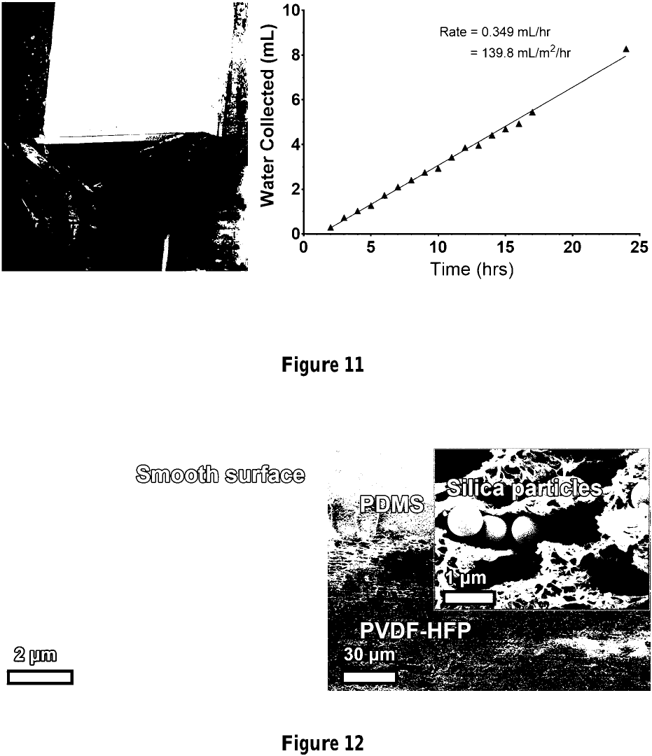

FIG. 10 (bottom left) is the advancing contact angle (ACA) and receding contact angle (RCA) of water over the composite coating surface and FIG. 11 (bottom right) illustrates a 30 µL water droplet over a composite coating surface inclined at 60 o. No roll-off occurred.

FIG. 11 (left hand) illustrates water droplets condensed on the surface of composite coating in laboratory condensation chamber at 10 oC below dew point and 85% relative humidity. FIG. 12 (right side) illustrates water collected over time and rate of condensation measured as 139.8 mL per m2 per hour.

Example 4 demonstrates wettability properties that favour condensation compared to Example 3 at the cost of reduced solar reflectivity and IR emissivity.

### Example 5: Composite Coating Demonstration 3. Two Layer PDMS Over PVDF-HFP Composite Containing SiO₂ Nanoparticles on an Aluminium Sheet Substrate

### Materials

Composition of liquid composite coating: 9.7% (wt. %) PVDF-HFP powder (HFP portion 20%-35% wt.%); 0.3% (wt. %) SiO2 nanospheres, 800 nm diameter; 80% (wt. %) acetone; and 10% (wt. %) deionised water.

Composition of outer surface layer: 100% 2-component mix-curing PDMS elastomer.

### Liquid Composite Coating Preparation

SiO₂ nanospheres were weighed into a suitable container with deionised water to prepare a 30 mg/mL dispersion. The mixture was sonicated for 2 hours and set aside ready for use. The PVDF-HFP polymer was weighed into a suitable container and mixed in pure acetone at 50° C. by constantly stirring for 45 minutes. Measured SiO₂ nanosphere aqueous dispersion was transferred to a syringe and added dropwise to the PVDF-HFP in acetone solution. The mixture was further stirred at 50° C. for 45 minutes, and then removed from heat and degassed by sonication for 5 minutes. The liquid composite coating was stored in a 20 mL container at 50° C.

### Substrate Preparation

Aluminum Alloy 1100 sheet was used as the substrate. The aluminum sheet was cut into approx. 25 cm × 30 cm and 6 cm × 7 cm pieces. The substrates were sanded with P1200 sandpaper, and cleaned with ethanol, then sonicated in 1% wt. sodium hydroxide aqueous solution for 15 minutes, then immersed in 1 molL⁻¹ iron (III) chloride solution for 7.5 minutes, and eventually immersed in gently boiling water for 30 minutes. This treatment ensured adhesion of the composite coating onto the aluminum surface without the need of primer or adhesion promoter. The substrates were sonicated in ethanol and blow dried with high pressure nitrogen before use for coating.

### Composite Coating Application

The liquid composite coating was sonicated for 5 minutes and then conditioned at ambient temperature for 30 minutes. An adjustable blade applicator was set to a 1 mm gap. 3 mL of liquid composite coating was deposited on the 6 cm × 7 cm treated aluminum substrate with a disposable syringe and then spread by the applicator to achieve a wet film of approximately 1 mm thick. Alternatively, when preparing composite coating for cooling assessment, approx. 60 mL of solution was deposited on the 25 cm × 30 cm treated aluminum substrate. The wet film was left for drying in an ambient environment (20-26° C. temperature and 40-70% relative humidity). The acetone and water were allowed to evaporate off the wet film in open air for 24 hours.

Appropriate volumes of each part of the two-component PDMS elastomer were mixed in 1:1 ratio thoroughly with a spatula. An adjustable blade applicator was set to a 0.1 mm gap. Mixed PDMS was deposited on the dried PVDF-HFP based coating with a spatula and then spread by the applicator. The PDMS was allowed for cure under ambient environment for 30 minutes. A composite coating consisted of porous PVDF-HFP with embedded SiO₂ sealed with PDMS top layer was formed.

### Composite Coating Film Characterisation

The dry film thickness was measured by a coating thickness gauge. The thickness was around 80 - 120 micrometer. The hemispherical spectral reflectance in UV/Visible/Near infrared range (0.3 - 2.5 µm) was measured by a spectrometer equipped with a PTFE integrating sphere. The hemispherical spectral reflectance in near to far infra-red range (6000 - 180 cm-1) was measured by a Fourier-Transform-based spectrometer equipped with gold integrating sphere and a Deuterated Lanthanum α Alanine doped Tri-Glycine Sulphate detector with Caesium Iodide window. The spectral properties could demonstrate the passive cooling capability of the composite coating film. Scanning electron microscope was used to visualise surface and cross-sectional structure of the dry composite coating. Contact angle goniometer was used to characterise surface wettability of the composite coating.

### Characterisation Results

FIG. 12 (top left) illustrates the SEM micrograph of the surface of the composite film. FIG. 12 (top right) illustrates the SEM micrograph of the cross section of the composite film, the inset being of higher magnification and showing silica particles embedded between the voids within the composite coating.

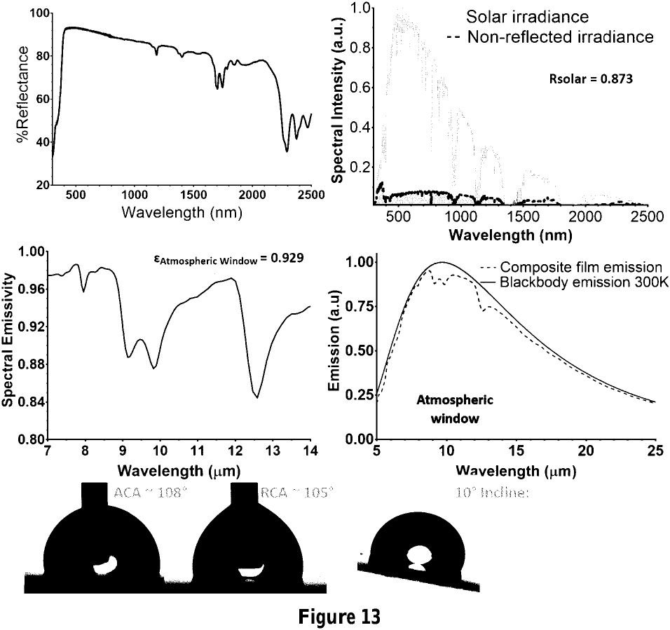

FIG. 13 (top left) illustrates spectral reflectivity over solar wavelengths (λ = 0.3 -2.5 µm) of composite coatings at approx. 90 µm thickness.

FIG. 13 (top right) illustrates the ASTM G173-03 Solar Spectrum Irradiance vs. non-reflected irradiance of an approx. 90 µm thick composite coating with 0.873 total solar reflectance;

FIG. 13 (middle left) shows spectral emissivity over atmospheric window (λ = 8 -13 µm) of approx. 160 µm thick composite coating.

FIG. 13 (middle right) shows blackbody radiation spectrum at 300 K vs. emission spectrum of composite coating at approx. 90 µm thick with 0.929 total atmospheric window emittance.

FIG. 13 (bottom left) shows advancing contact angle (ACA) and receding contact angle (RCA) of water over the composite coating surface.

FIG. 13 (bottom right) shows a 15 µL water droplet over an inclined composite coating surface. Roll-off of the water droplet occurred at around 10 o

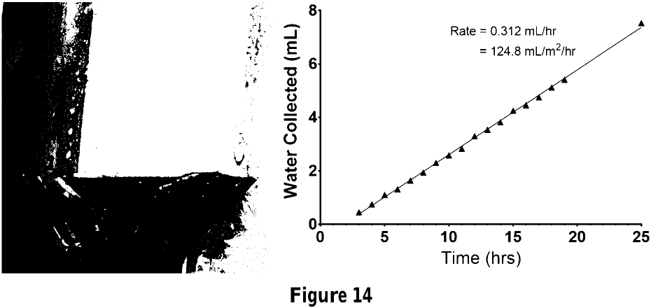

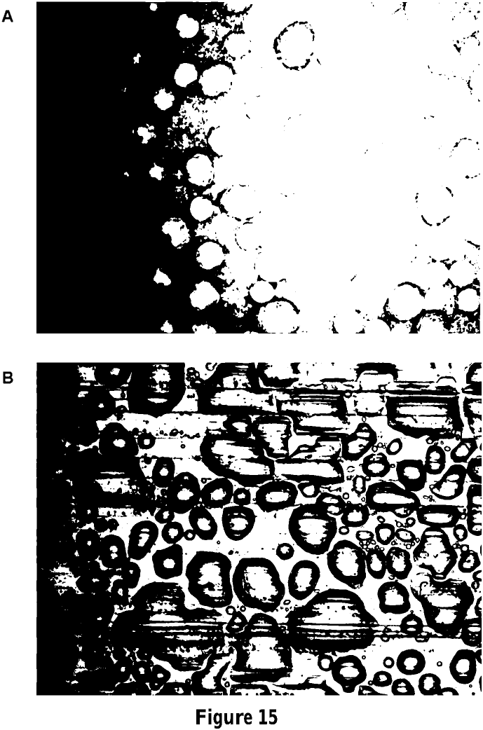

FIG. 14 (bottom left) shows water droplets condensed on the surface of composite coating in laboratory condensation chamber at 10 oC below dew point and 85% relative humidity.

FIG. 14 (bottom right) is a plot of water collected over time and the rate of condensation was calculated to be 124.8 mL per m2 per hour.

1. A composite coating for increasing atmospheric condensation on a surface of a substrate, wherein the composite coating comprises:
one or more hydrophobic polymers; and
wherein the composite coating comprises a plurality of inclusions.

2. The composite coating according to claim 1, wherein the inclusions comprise voids.

3. (canceled)

4. The composite coating according to claim 1, wherein the hydrophobic polymer comprises fluoropolymer, organosiloxane, or blends thereof.

5. The composite coating according to claim 4, wherein the hydrophobic polymer comprises PVDF-HFP, PDMS, or blends thereof.

6. The composite coating according to claim 1, further comprising one or more hydrophilic substances.

7. The composite coating according to claim 6, wherein the hydrophilic substance comprises one or more of inorganic particles and hydrophilic polymers.

8. The composite coating according to claim 7, wherein the inorganic particles comprise silica particles.

9. (canceled)

10. (canceled)

11. The composite coating according to claim 7, wherein the hydrophilic polymers comprise one or more of polyacrylate, polyester and polyether.

12. The composite coating according to claim 11, wherein the hydrophilic polymers comprise one or more of PMMA and PEG.

13. The composite coating according to claim 1, further comprising one or more surface modifying agents selected from the group consisting of polyurethane, polystyrene and silane.

14. The composite coating according to claim 1, wherein the composite coating is a layer having a thickness between 50 and 200 µm.

15. The composite coating according to claim 1, wherein the composite coating comprises at least two layers, and wherein the outer layer comprises one or more surface modifying agents comprising organosiloxane, polyurethane, fluoropolymer, polystyrene, polyacrylate and silane.

16. (canceled)

17. The composite coating according to claim 15, wherein the one or more surface modifying agents comprise one or more of PDMS, PVDF, PMMA, alkylsilane and haloalkylsilane.

18. (canceled)

19. A liquid composite coating comprising the composite coating according to one claim 1 and:
a solvent which is capable of substantially dissolving the hydrophobic polymer; and
a non-solvent, in which the hydrophobic polymer is insoluble, or sparingly soluble.

20. The liquid composite coating according to claim 19, wherein the mass ratio of the hydrophobic polymer to the solvent is from about 1:10 to about 1:5.

21. The liquid composite coating according to claim 19, wherein the mass ratio of the solvent to the non-solvent is from about 10:1 to about 5:1.

22. The liquid composite coating according to claim 19, wherein the non-solvent comprises water.

23. The liquid composite coating according to claim 19, wherein the solvent comprises a water-miscible organic solvent.

24. (canceled)

25. The liquid composite coating according to claim 23, wherein the water-miscible organic solvent comprises one or more of acetone, tetrahydrofuran and 1,3-dioxolane.

26. The liquid composite coating according to claim 19, further comprising N-methyl-2-pyrrolidone.

27. A method for producing a liquid composite coating according to claim 19, comprising:
mixing a hydrophobic polymer, optionally hydrophilic substance and surface modifying agents, and a solvent together to form a mixture, wherein the solvent is capable of at least partially dissolving the hydrophobic polymer; and
adding a non-solvent to the mixture to form the liquid composite coating, wherein the hydrophobic polymer is insoluble, or sparingly soluble in the non-solvent.

28. A method for coating a surface of a substrate with a composite coating according to claim 1, comprising
applying the liquid composite coating according to claim 1 to the surface of the substrate, and
removing at least a portion of the solvent and/or non-solvent to form the composite coating.

29. A method for coating a surface of a substrate with a composite coating comprising:
applying the liquid composite coating according to claim 19 to the surface of a substrate;
removing at least a portion of the solvent and/or non-solvent from the liquid composite coating to form a first layer of the composite coating; and
applying one or more surface modifying agents comprising organosiloxane, polyurethane, fluoropolymer, polystyrene and polyacrylate to the first layer to form a second layer of the composite coating.

30. (canceled)

31. The method according to claim 28, further comprising applying a primer to the substrate prior to applying the liquid composite coating.

32. The method according to claim 31, wherein the primer comprises one or more of acrylic, epoxy and polyurethane polymer, anticorrosion pigment, reflective pigment, IR emitter (for example SiC and Si₃N₄) and adhesion promoting additives.

33. The method according to claim 31, wherein the primer is a layer having a thickness between about 30 µm and 100 µm.

34. A method for increasing atmospheric condensation on a surface of a substrate exposed to sky, comprising coating the substrate with the composite coating according to claim 1.

35. (canceled)

36. A method for collecting atmospheric water, said method comprising:
exposing a substrate coated with the composite coating according to claim 1 to sky, under atmospheric conditions having a relative humidity of about 30% or more, to condense atmospheric water on the substrate; and
collecting the condensed atmospheric water.

37. (canceled)

38. A method according to claim 36, wherein greater than 0.1 L of condensed water is collected per m² of coated substrate surface per 24 hour day.

39. (canceled)

40. (canceled)

41. A system for collecting condensed atmospheric water, said system comprising:
a substrate coated with the composite coating according to claim 1, wherein the coated substrate is exposed to the sky; and
means for transporting condensed atmospheric water from the coated substrate to one or more collection units.

42-49. (canceled)
